(19) United States
(12) Patent Application Publication
(10) Pub. No.: US 2022/0237678 A1
(43) Pub. Date: Jul. 28, 2022

(54) METHOD AND DEVICE FOR ESTABLISHING INFORMATION MODEL AND NON-VOLATILE COMPUTER READABLE RECORDING MEDIUM

(71) Applicant: Industrial Technology Research Institute, Hsinchu (TW)

(72) Inventors: Yu-Chiao Wang, Taichung City (TW); Xiao Hu, Hsinchu City (TW); Min-Hao Li, Hsinchu County (TW)

(73) Assignee: Industrial Technology Research Institute, Hsinchu (TW)

(21) Appl. No.: 17/232,118

(22) Filed: Apr. 15, 2021

(30) Foreign Application Priority Data
Jan. 25, 2021 (TW) 110102671

(51) Int. Cl. G06Q 30/06; G06Q 30/02; G06F 40/289; G06Q 50/04

(52) U.S. Cl. CPC G06Q 30/0625; G06Q 30/0281; G06F 16/9027; G06Q 50/04; G06F 40/289

(57) ABSTRACT

A method for establishing an information model is disclosed according to embodiment of the disclosure. The method includes steps below. A description data of a product is obtained. A resource description framework (RDF) graph is generated according to the description data. The RDF graph is compared with at least one first international standard model. An information model corresponding to the product is established according to a comparison result, and the information model is configured to provide information related to the product.

### CROSS-REFERENCE TO RELATED APPLICATION

This application claims the priority benefit of Taiwan application serial no. 110102671, filed on Jan. 25, 2021. The entirety of the above-mentioned patent application is hereby incorporated by reference herein and made a part of this specification.

### BACKGROUND

### Technical Field

The disclosure relates to a technique for converting a description data of a product into an information model which conforms to an international standard, and particularly relates to a method and a device for establishing an information model, and a non-volatile computer-readable recording medium.

### Description of Related Art

In the architecture of Industry 4.0, it is expected that a highly interoperable information model for information exchange of descriptions (e.g., product specification descriptions) of products (e.g., electronic circuits or equipment) can be achieved among multiple manufacturers. However, current digital information models are mainly established manually and take much time to operate. In addition, currently, the establishment of information models does not effectively use the information model specifications of international standards, so that information generally cannot be directly communicated among the information models established by different manufacturers.

### SUMMARY

The disclosure provides a method and a device for establishing an information model, and a non-volatile computer-readable recording medium, which can efficiently and automatically establish an information model of a product and improve the convenience of the information model in information exchange.

An embodiment of the disclosure provides a method for establishing an information model, including steps below. A description data of a product is obtained. A resource description framework (RDF) graph is generated according to the description data. The RDF graph is compared with at least one first international standard model. An information model corresponding to the product is established according to a comparison result. The information model is configured to provide information related to the product.

An embodiment of the disclosure further provides a device for establishing an information model, including a storage circuit and a processor. The storage circuit is configured to store a description data of a product. The processor is coupled to the storage circuit and is configured to generate an RDF graph according to the description data, compare the RDF graph with at least one first international standard model, and establish an information model corresponding to the product according to a comparison result. The information model is configured to provide information related to the product.

An embodiment of the disclosure further provides a non-volatile computer-readable recording medium. The non-volatile computer-readable recording medium stores a program code, and the program code is executed by a processor to obtain a description data of a product, generate an RDF graph according to the description data, compare the RDF graph with at least one first international standard model, and establish an information model corresponding to the product according to a comparison result. The information model is configured to provide information related to the product.

Based on the above, after a description data of a product is obtained, an RDF graph may be generated according to the description data. The RDF graph is compared with at least one first international standard model. An information model corresponding to the product is established according to the comparison result. The information model is configured to provide information related to the product. Accordingly, the information model of the product can be established efficiently and automatically, and the convenience of the information model in information exchange can be improved.

To make the aforementioned more comprehensible, several embodiments accompanied with drawings are described in detail as follows.

### BRIEF DESCRIPTION OF THE DRAWINGS

FIG. 1 is a schematic view of a management system of an information model according to an embodiment of the disclosure.

FIG. 2 is a functional block diagram of a device for establishing an information model according to an embodiment of the disclosure.

FIG. 3 is a schematic view of an operation of automatically establishing an information model according to an embodiment of the disclosure.

FIG. 4 is a schematic view of an RDF according to an embodiment of the disclosure.

FIG. 5 is a schematic view of an RDF graph according to an embodiment of the disclosure.

FIG. 6 is a schematic view showing training and using a classifier according to an embodiment of the disclosure.

FIG. 7 is a flowchart of a method for establishing an information model according to an embodiment of the disclosure.

### DESCRIPTION OF THE EMBODIMENTS

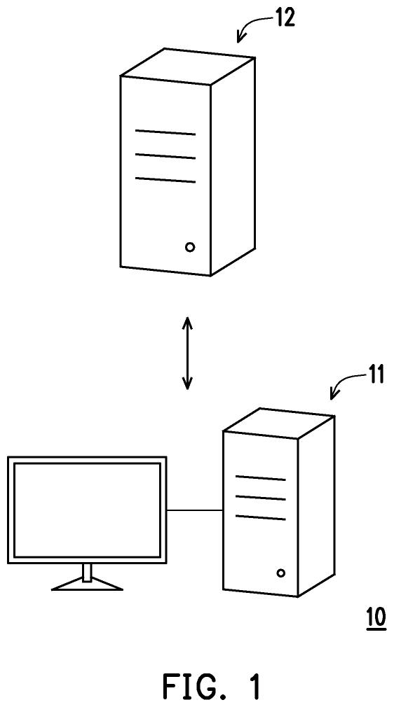

FIG. 1 is a schematic view of a management system of an information model according to an embodiment of the disclosure. Referring to FIG. 1, a system (also referred to as a management system of an information model) 10 includes a device (also referred to as a device for establishing an information model) 11. The device 11 may include a desktop computer, a notebook computer, a tablet computer, an industrial computer, a server, or other computer devices having data processing functions. The device 11 may obtain a description data of one or more products. For example, the product may include various electronic components, electronic circuits, electronic equipment, industrial equipment, commercial equipment, household appliances, etc. The description data of the product may include at least one of a product catalog data, a circuit diagram, a mechanical structure diagram, an international product classification number, a webpage link, and a communication interface specification data related to the product. The device 11 may automatically generate and establish an information model corresponding to the product according to the description data of the product, so as to provide information related to the product through the information model. It is noted that the information model may conform to a specific international standard (e.g., RAMI, SSN, AML, SCORVoc, etc.). Accordingly, different manufacturers (i.e., client-end devices) may access the information model according to the internationally recognized standard to obtain information related to the product.

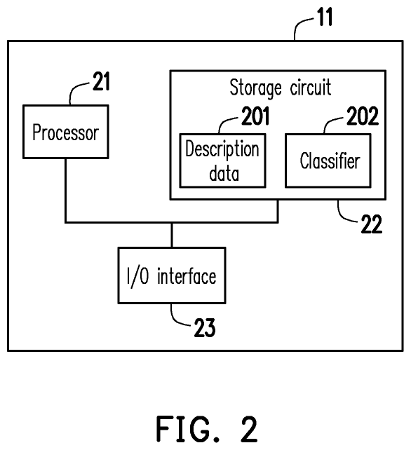

FIG. 2 is a functional block diagram of a device for establishing an information model according to an embodiment of the disclosure. Referring to FIG. 2, the device 11 includes a processor 21, a storage circuit 22, and an input/output (I/O) interface 23. The processor 21 is configured to control the overall or part of the operation of the device 11. For example, the processor 21 may include a central processing unit (CPU), other programmable general-purpose or specific-purpose microprocessor, digital signal processor (DSP), programmable controller, application specific integrated circuit (ASIC), programmable logic device (PLD), or other similar devices, or a combination of the above devices.

The storage circuit 22 is coupled to the processor 21 and is configured to store data. For example, the storage circuit 22 may include a volatile storage circuit and a non-volatile storage circuit. The volatile storage circuit is configured to volatilely store data. For example, the volatile storage circuit may include a random access memory (RAM) or similar volatile storage media. The non-volatile storage circuit is configured to non-volatilely store data. For example, the non-volatile storage circuit may include a read only memory (ROM), a solid state disk (SSD), and/or a conventional hard disk drive (HDD), or similar non-volatile storage media.

The I/O interface 23 is coupled to the processor 21 and is configured to transmit signals. For example, the processor 21 may receive an input signal or transmit an output signal via the I/O interface 23. For example, the I/O interface 23 may include various I/O devices such as a network connection interface, a mouse, a keyboard, a screen, a touch panel, and/or a speaker.

In an embodiment, the storage circuit 22 stores a description data 201. The description data 201 records information related to a specific product. In an example where the specific product is a sensor, the description data 201 may include a product catalog data, a circuit diagram, a mechanical structure diagram, an international product classification number, a webpage link, and/or a communication interface specification data related to the sensor. In addition, different types of products may correspond to different types of description data 201.

In an embodiment, the storage circuit 22 further stores a classifier 202. The classifier 202 may perform image recognition on a specific image and may classify this image. For example, in the process of generating an information model corresponding to the specific product, a resource description framework (RDF) graph may be temporarily used. The classifier 202 may perform image recognition on this RDF graph and determine whether the RDF graph conforms to a specific international standard model. In addition, the classifier 202 may be trained to improve the accuracy of its image recognition and/or classification.

It is noted that, in the embodiment of FIG. 2, the classifier 202 is implemented in the form of software and stored in the storage circuit 22. However, in another embodiment, the classifier 202 may also be implemented in the form of a hardware circuit, for example, as one or more image processing chips. The classifier 202 implemented in the form of a hardware circuit may be installed inside the processor 21 or independent of the processor 21.

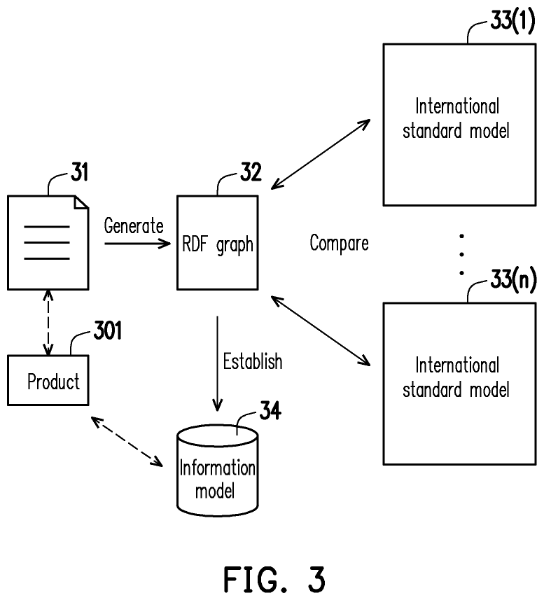

FIG. 3 is a schematic view of an operation of automatically establishing an information model according to an embodiment of the disclosure. Referring to FIG. 2 and FIG. 3, assuming that the description data 201 includes a description data 31, the processor 21 may obtain the description data 31 of a product 301 from the storage circuit 22. For example, the description data 31 may include a product catalog data, a circuit diagram, a mechanical structure diagram, an international product classification number, a webpage link, and/or a communication interface specification data related to the product 301. The processor 21 may analyze the description data 31 and generate an RDF graph 32 according to the analysis result of the description data 31.

Then, the processor 21 may compare the RDF graph 32 with international standard models (also referred to as first international standard models) 33(1) to 33(n). “n” may be any positive integer. According to the comparison result, the processor 21 may automatically establish an information model 34 corresponding to the product 301. The information model 34 may be configured to provide information related to the product 301. For example, the information related to the product 301 may include information recorded in the product catalog of the product 301, information recorded in the circuit diagram of the product 301, information recorded in the mechanical structure diagram of the product 301, information of the international product classification number of the product 301, information of the webpage link of the product 301, the communication interface specification data of the product 301, and/or any other information related to the product 301.

In an embodiment, the processor 21 may communicate with a user via a dialogue service interface. Then, the processor 21 may obtain at least part of the data in the description data 31 according to the communication result. For example, the dialogue service interface may be presented on a screen of the device 11 and/or output voice messages via a speaker of the device 11 to communicate (or interact) with the user. For example, the user may input a data required by the processor 21 via this dialogue service interface, such as a type of the product 301, a name of the product 301, an identification (e.g., an ID, a webpage link, or a QR code) of the product 301, a function of the product 301, an attribute of the product 301, an applicable communication interface specification of the product 301, and/or other useful information. The processor 21 may add the data received from the user via the dialogue service interface into the description data 31 as at least part of the data in the description data 31.

In an embodiment, the original description data 31 is uploaded by the user (e.g., uploading to the storage circuit 22). In an embodiment, the processor 21 may determine whether the content of the description data 31 uploaded by the user is sufficient and/or determine the lacking content, so as to determine whether to activate the dialogue service interface and/or determine the type of data to request the user via the dialogue service interface.

In an embodiment, the processor 21 may analyze a text data corresponding to the description data 31 by natural language processing (NLP). For example, the processor 21 may convert the description data 31 into a text data. This text data may record at least part of the information mentioned in the description data 31 in a computer-readable text format. The processor 21 may generate the RDF graph 32 according to the analysis result of the text data.

In an embodiment, in the process of generating the RDF graph 32, the processor 21 may analyze the text data corresponding to the description data 31 by natural language processing to generate an RDF. For example, the processor 21 may tag parts of speech for at least part of the data content of the text data corresponding to the description data 31 according to a predetermined professional vocabulary. Then, the processor 21 may perform a series of natural language processing on the tagging result to generate an RDF. Afterwards, the processor 21 may generate the RDF graph 32 according to the RDF.

In an embodiment, the text data corresponding to the description data 31 may include information conforming to a production system communication data exchange format (.aml). This information may be applied to a production system to describe information such as a topological structure data, a mechanical data, a system data associated with electricity, gas, oil, etc., a product function description data, and a control process data, and the information belongs to an open international standard. The processor 21 may analyze the information conforming to the production system communication data exchange format (.aml) to generate the RDF graph 32.

In an embodiment, the processor 21 may annotate the text data corresponding to the description data 31 in relation to at least one industrial semantic vocabulary. Then, the processor 21 may map the annotated text data to a web ontology language (OWL) format. Afterwards, the processor 21 may generate the RDF graph 32 according to the mapping result. For example, the industrial semantic vocabulary may include aml, rami, sto, etc.

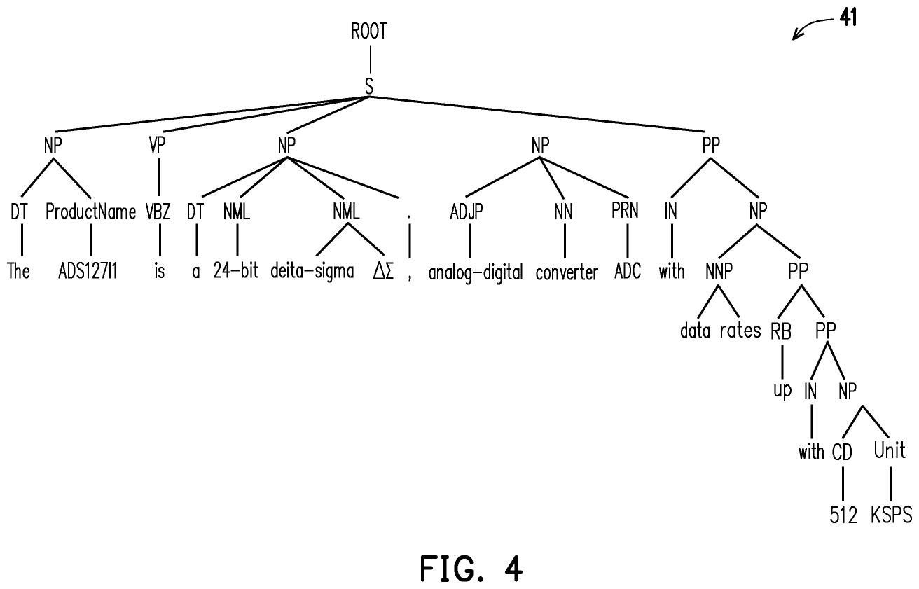

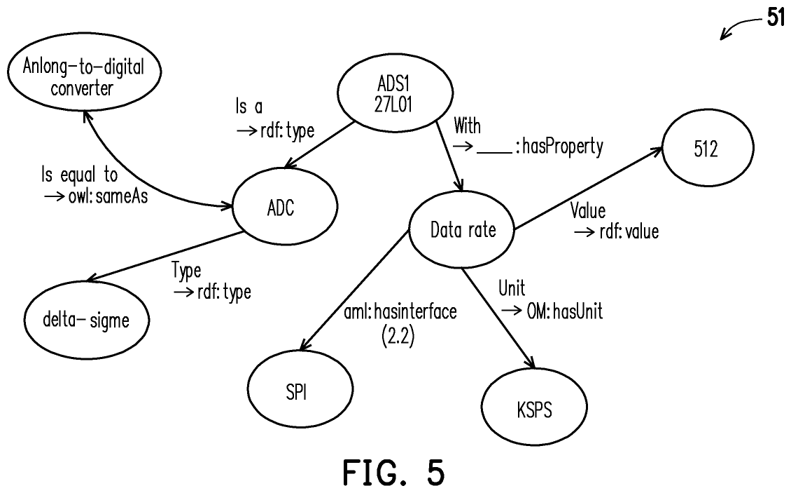

FIG. 4 is a schematic view of an RDF according to an embodiment of the disclosure. FIG. 5 is a schematic view of an RDF graph according to an embodiment of the disclosure. Referring to FIG. 4 and FIG. 5, by natural language processing, the processor 21 may analyze the text data corresponding to the description data 31 and/or analyze the information in the text data which conforms to the production system communication data exchange format (.aml) to generate an RDF 41. Then, the processor 21 may query at least one industrial semantic vocabulary and map the RDF 41 to the web ontology language format according to the query result to generate an RDF graph 51. It is noted that the RDF graph 51 may serve as an example of the RDF graph 32. However, the contents shown in the RDF 41 in FIG. 4 and the RDF graph 51 in FIG. 5 are only examples and may be adjusted according to the practical requirements.

Referring back to FIG. 3, in an embodiment, after the RDF graph 32 is initially obtained, the processor 21 may determine whether a defect is present in the RDF graph 32. For example, the defect may include information which cannot be automatically annotated in the RDF graph 32. If a defect is present in the RDF graph 32, the processor 21 may receive a user operation and add a supplementary data into the RDF graph 32 according to the user operation. Taking FIG. 5 as an example, assuming that, in the RDF graph 51, it is not clear to which vocabulary the word “With” belongs, so a corresponding annotation cannot be generated (i.e., a defect is present). In an embodiment, the processor 21 may allow the user to annotate in the RDF graph 51 the vocabulary to which the word “With” belongs, e.g., belonging to “sto” or other vocabularies, by this user operation. In addition, if there is no defect in the RDF graph 32, the processor 21 may skip this operation.

In an embodiment, the processor 21 may compare, by the classifier 202, the RDF graph 32 with the international standard models 33(1) to 33(n). For example, the processor 21 may input the RDF graph 32 to the classifier 202. Then, the processor 21 may establish the information model 34 corresponding to the product 301 according to the output of the classifier 202.

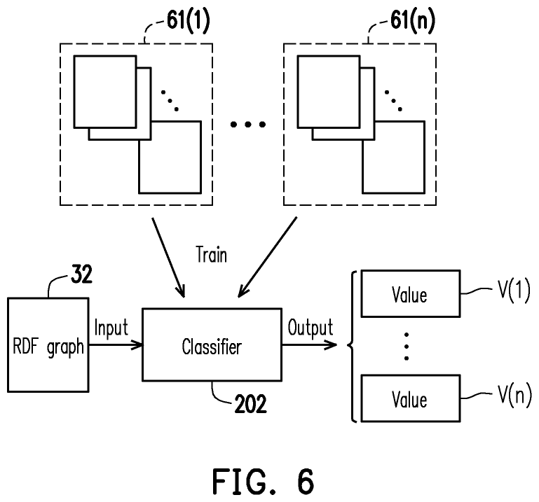

FIG. 6 is a schematic view showing training and using a classifier according to an embodiment of the disclosure. Referring to FIG. 6, in an embodiment, the processor 21 may train the classifier 202 by using training datasets 61(1) to 61(n) corresponding to the international standard models 33(1) to 33(n). For example, a training dataset 61(i) among the training datasets 61(1) to 61(n) may include one or more folded graphs of the model topology corresponding to an international standard model 33(i). The trained classifier 202 may be used to identify a graph class which conforms to at least one of the international standard models 33(1) to 33(n). In an embodiment, as the types of the training datasets 61(1) to 61(n) used to train the classifier 202 increases and/or the number of the folded graphs in the topology model increases, the identification capability of the trained classifier 202 with respect to the graph class also improves.

In an embodiment, the classifier 202 may generate output values V(1) to V(n) according to the inputted RDF graph 32. An output value V(i) may reflect a probability value by which the classifier 202 believes that the currently inputted RDF graph 32 conforms to the international standard model 33(i). “i” may be any positive integer between 1 and n. A larger output value V(i) means a higher probability by which the classifier 202 believes that the RDF graph 32 conforms to the international standard model 33(i). Conversely, a smaller output value V(i) means a lower probability by which the classifier 202 believes that the RDF graph 32 conforms to the international standard model 33(i). In an embodiment, the sum of V(1) to V(n) may be “1”.

In an embodiment, the processor 21 may determine whether the output value V(i) of the classifier 202 is greater than a predetermined value. For example, this predetermined value may be “0.75”. If the output value V(i) is greater than the predetermined value, the processor 21 may determine that the RDF graph 32 conforms to the international standard model 33(i). However, in an embodiment, if none of the output values V(1) to V(n) of the classifier 202 is greater than the predetermined value, the processor 21 may determine that the current classifier 202 fails to identify the graph class of the RDF graph 32.

In an embodiment, if graph class identification fails (i.e., none of the output values V(1) to V(n) is greater than the predetermined value), the processor 21 may receive a user operation and determine an international standard model (also referred to as a second international standard model) to which the RDF graph 32 conforms according to the user operation. It is possible that this second international standard model is not included in the international standard models 33(1) to 33(n). In other words, once the classifier 202 cannot correctly identify the international standard model to which the RDF graph 32 conforms, the processor 21 may immediately allow the user to intervene to manually determine the international standard model to which the RDF graph 32 truly conforms.

In an embodiment, after determining the international standard model (i.e., the second international standard model) to which the RDF graph 32 conforms according to the user operation, the processor 21 may update the international standard models 33(1) to 33(n) according to the second international standard model. For example, the processor 21 may add the second international standard model into the international standard models 33(1) to 33(n). In addition, the processor 21 may add the training dataset corresponding to the second international standard model into the training datasets 61(1) to 61(n) to expand the types of the training datasets 61(1) to 61(n). Accordingly, the trained classifier 202 may later be used to identify an RDF graph conforming to the second international standard model.

It is noted that, in the above embodiment of FIG. 6, the total number of the output values V(1) to V(n) is equal to the total number of the international standard models 33(1) to 33(n) (or the training datasets 61(1) to 61 (n)). However, in another embodiment of FIG. 6, it is possible that the total number of the output values V(1) to V(n) is not equal to the total number of the international standard models 33(1) to 33(n) (or the training datasets 61(1) to 61(n)), and the disclosure is not limited thereto.

In an embodiment, the processor 21 may further extract at least part of the information from the RDF graph 32 according to the international standard model to which the RDF graph 32 conforms. Then, the processor 21 may store the extracted information (e.g., storing in the storage circuit 22) based on an OPC Unified Architecture (OPC UA). In other words, the processor 21 may further map (or convert) the RDF graph 32 from the original specific international standard model to a model architecture conforming to the OPC UA for storage. Accordingly, other devices (e.g., remote devices) may connect to the device 11 and access the above information related to the product 301 based on the more universal OPC UA model architecture. Compared with the case where different client-end devices may access the information model by different international standard models, storing the information model based on the more universal OPC UA model architecture can further improve the convenience of accessing the information model among the client-end devices.

Referring back to FIG. 1, in an embodiment, the system 10 further includes a server 12. The device 11 may be connected to the server 12 via a network (e.g., the Internet). In an embodiment, the processor 21 may store the established information model 34 corresponding to the product 301 to the server 12 via the I/O interface 23, so as to allow other client-end devices (or remote devices) to connect to the server 12 to access the information model 34. Specifically, the information model 34 transmitted to the server 12 may be stored based on a specific international standard (e.g., RAMI, SSN, AML, SCORVoc, etc.) or a more universal OPC UA model architecture, and the disclosure is not limited thereto.

An embodiment of the disclosure provides a non-volatile computer-readable recording medium. The non-volatile computer readable recording medium stores a program code. A processor (e.g., the processor 21 in FIG. 2) in a computer may execute (or run) this program code to execute the above functions and operations.

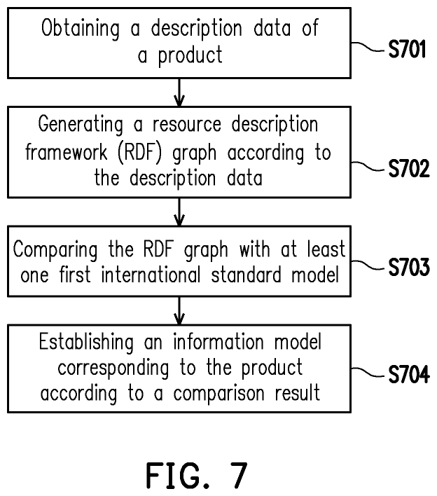

FIG. 7 is a flowchart of a method for establishing an information model according to an embodiment of the disclosure. Referring to FIG. 7, in step S701, a description data of a product is obtained. In step S702, an RDF graph is generated according to the description data. In step S703, the RDF graph is compared with at least one first international standard model. In step S704, an information model corresponding to the product is established according to a comparison result, where the information model is configured to provide information related to the product.

Details of each step in FIG. 7 have been described as above and will not be repeatedly described herein. It is noted that each step in FIG. 7 may be implemented as multiple program codes (e.g., software modules) or circuits (e.g., circuit modules), and the disclosure is not limited thereto. In addition, the method in FIG. 7 may be applied in conjunction with the above exemplary embodiments or may be applied alone, and the disclosure is not limited thereto.

In summary of the above, in the embodiments of the disclosure, an information model corresponding to the product is automatically generated and established according to the description data of the product, so as to provide information related to the product through the information model. Accordingly, different manufacturers (e.g., client-end devices) may access the information model according to the internationally recognized standard to obtain information related to the product.

Compared to the conventional approach which requires to manually refer to specification descriptions of the product to establish the required information model, in the embodiments of the disclosure, the information model of the product is automatically established according to the description data of the product, which can effectively improve the efficiency of establishing the information model and the accuracy of the data. In addition, compared with the conventional approach in which the information models established among different client-end devices may not be compatible with each other, in the embodiments of the disclosure, the established information model conforms to the common international standard, so multiple client-end devices may easily access the information model established by each other to obtain the required product information, which thereby improves the convenience of the information model in information exchange.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for establishing an information model, comprising:
obtaining a description data of a product;
generating a resource description framework graph according to the description data;
comparing the resource description framework graph with at least one first international standard model; and
establishing an information model corresponding to the product according to a comparison result, wherein the information model is configured to provide information related to the product.

2. The method for establishing an information model according to claim 1, wherein the description data of the product comprises at least one of a product catalog data, a circuit diagram, a mechanical structure diagram, an international product classification number, a webpage link, and a communication interface specification data.

3. The method for establishing an information model according to claim 1, wherein the step of obtaining the description data of the product comprises:
communicating with a user via a dialogue service interface; and
obtaining at least part of a data in the description data of the product according to a communication result.

4. The method for establishing an information model according to claim 1, wherein the step of generating the resource description framework graph according to the description data comprises:
analyzing a text data corresponding to the description data by natural language processing; and
generating the resource description framework graph according to an analysis result.

5. The method for establishing an information model according to claim 4, wherein the text data comprises information conforming to a production system communication data exchange format Came.

6. The method for establishing an information model according to claim 4, wherein the step of generating the resource description framework graph according to the analysis result comprises:
annotating the text data in relation to at least one industrial semantic vocabulary;
mapping the annotated text data to a web ontology language format; and
generating the resource description framework graph according to a mapping result.

7. The method for establishing an information model according to claim 4, wherein the step of generating the resource description framework graph according to the description data further comprises:
determining whether a defect is present in the resource description framework graph; and
receiving a user operation and adding a supplementary data into the resource description framework graph according to the user operation, if the defect is present in the resource description framework graph.

8. The method for establishing an information model according to claim 1, wherein the steps of comparing the resource description framework graph with the at least one first international standard model and establishing the information model corresponding to the product according to the comparison result comprise:
inputting the resource description framework graph to a classifier, wherein the classifier is trained to identify a graph class which conforms to the at least one first international standard model; and
establishing the information model corresponding to the product according to an output of the classifier.

9. The method for establishing an information model according to claim 8, wherein the step of establishing the information model corresponding to the product according to the output of the classifier comprises:
determining whether an output value of the classifier is greater than a predetermined value; and
determining that the resource description framework graph conforms to at least one of the at least one first international standard model, if the output value is greater than the predetermined value.

10. The method for establishing an information model according to claim 9, wherein the step of establishing the information model corresponding to the product according to the output of the classifier further comprises:
receiving a user operation and determining a second international standard model to which the resource description framework graph conforms according to the user operation, if none of the output values of the classifier is greater than the predetermined value, wherein the second international standard model is not included in the at least one first international standard model.

11. The method for establishing an information model according to claim 1, wherein the step of establishing the information model corresponding to the product according to the comparison result comprises:
extracting information from the resource description framework graph according to an international standard model to which the resource description framework graph conforms; and
storing the extracted information based on an OPC Unified Architecture.

12. A device for establishing an information model, comprising:
a storage circuit configured to store a description data of a product; and
a processor coupled to the storage circuit and configured to:
generate a resource description framework graph according to the description data,
compare the resource description framework graph with at least one first international standard model, and
establish an information model corresponding to the product according to a comparison result, wherein the information model is configured to provide information related to the product.

13. A non-volatile computer-readable recording medium, wherein the non-volatile computer-readable recording medium stores a program code, and the program code is executed by a processor to:
obtain a description data of a product,
generate a resource description framework graph according to the description data,
compare the resource description framework graph with at least one first international standard model, and
establish an information model corresponding to the product according to a comparison result, wherein the information model is configured to provide information related to the product.
